(19) United States
(12) Patent Application Publication
(10) Pub. No.: US 2014/0259734 A1
(43) Pub. Date: Sep. 18, 2014

(54) Arrangements for and Methods of Drying Wood

(71) Applicant: ShelterLogic Corp., Watertown, CT (US)

(72) Inventors: George LeMoine, Trumbull, CT (US); Derald L. Shepherd, Torrington, CT (US)

(73) Assignee: ShelterLogic Corp., Watertown, CT (US)

(21) Appl. No.: 14/201,073

(22) Filed: Mar. 7, 2014

Related U.S. Application Data
(60) Provisional application No. 61/789,511, filed on Mar. 15, 2013.

(51) Int. Cl. F26B 3/28; F26B 25/06; F26B 25/10; F26B 3/30

(52) U.S. Cl. CPC F26B 3/286; F26B 3/30; F26B 25/066; F26B 25/10
USPC 34/512; 34/93; 34/239

(57) ABSTRACT

An arrangement for drying wood including a framed structure for creating an area, an optional support structure for supporting wood placed thereon, a cover, wherein the cover is supported by the framed structure and wherein the cover has water resistant properties and allows infrared radiation to pass through the cover to warm the wood, wherein the cover is constructed to facilitate the escaping of some moisture from the arrangement through one or more vents in the cover and collect other moisture on an inner surface of the cover and permit at least some of the other moisture to run down along the inner surface of the cover towards the ground; wherein a system is created at least in part by the cover to accelerate the drying of the wood. A method of drying the wood is also provided.

### BACKGROUND OF THE INVENTION

This invention relates generally to arrangements for at least drying wood, and more particularly to improved arrangements and methods for at least drying wood that provides for an acceleration and increased efficiency of wood drying time. In the preferred embodiments, the wood is firewood and the methods and arrangements also provide for the storing of said wood.

Firewood racks are known generally, such as from U.S. Pat. No. 6,290,073 and U.S. Publication No. 2008/0290053. Similarly, firewood covers are known, such as from U.S. Pat. No. 5,572,833. However, the present invention is more than a simple combination of prior art elements. In fact, it is believed that the prior art suffers from a perceived lack of appreciation of the benefits of enclosing, covering and at least drying the wood as claimed herein. Specifically, the inventors of the present invention are unaware of any arrangement or methodology for at least drying and optionally storing wood that achieves the unexpected and surprising efficiency and accelerated drying of the wood as achieved by the present invention.

Accordingly, an improved arrangement and method for at least drying wood and thereafter optionally also storing the wood, and firewood in particular, that overcomes the drawbacks found in the prior art while at the same time achieves the unexpected and superior efficiency as set forth herein, is desired.

### SUMMARY AND OBJECTIVES OF THE PRESENT INVENTION

Generally speaking, in accordance with a first preferred embodiment of the present invention, an arrangement for drying wood is provided. In such a preferred embodiment, the arrangement comprises a framed structure for creating an area within the framed structure; a cover, wherein the cover is supported by the framed structure and wherein the cover (i) has water resistant properties for inhibiting water from entering the area created within the framed structure and (ii) allows infrared radiation to pass through the cover to warm wood positioned in the space created within the framed structure, whereby warming of wood that has moisture therein permits evaporation of said moisture from said wood; and wherein the cover is further constructed to (i) facilitate the escaping of some moisture from the arrangement through one or more vents in the cover and (ii) collect other moisture on an inner surface of the cover and permit at least some of the other moisture to run down along the inner surface of the cover towards the ground; wherein a system is created at least in part by the cover to accelerate the drying of the wood positioned in the area created within the framed structure.

In accordance with another preferred embodiment of the present invention, a method of drying wood is provided. In one preferred embodiment, the method utilizes an arrangement comprising a framed structure for creating an area within the framed structure; a cover, wherein the cover is supported by the framed structure and wherein the cover (i) has water resistant properties for inhibiting water from entering the area created within the framed structure and (ii) allows infrared radiation to pass through the cover to warm wood positioned in the space created within the framed structure, whereby warming of wood that has moisture therein permits evaporation of said moisture from said wood; and wherein the cover is further constructed to (i) facilitate the escaping of some moisture from the arrangement through one or more vents in the cover and (ii) collect other moisture on an inner surface of the cover and permit at least some of the other moisture to run down along the inner surface of the cover towards the ground; wherein the method comprises the steps of warming the wood via infrared radiation passing through the cover; evaporating moisture in the wood; venting at least some of the moisture evaporated from the wood; collecting at least some other moisture evaporated from the wood on the inner surface of the cover and permitting at least some of the other moisture to run down along the inner surface of the cover towards the ground; wherein a system is created at least in part by the cover to accelerate the drying of the wood positioned in the area created by the framed structure.

In a specific embodiment, the arrangement comprises wood placed on a support structure. In yet a more specific embodiment, the wood is suitable as firewood.

Accordingly, it is an object of the present invention to achieve a faster drying time with improved efficiency of wood over that found in the current state of the art.

It is also an object of the present invention to achieve such faster drying time with improved efficiency using a shed-like arrangement that can be easily constructed, maintained and even disassembled, if needed.

Still other objects and advantages of the invention will in part be obvious and will in part be apparent from the specification.

The invention accordingly comprises the features of construction, combination of elements, sequence of steps and arrangement of parts which will be exemplified in the construction and methodology hereinafter set forth, and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1 is a perspective view of an arrangement for at least drying wood and optionally storing said wood, constructed in accordance with a first embodiment of the present invention;

FIG. 2 is a front view of the arrangement for at least drying wood and optionally storing said wood, as illustrated in FIG. 1;

FIG. 3 is an enlarged view of the section of the arrangement of FIG. 2 labeled as such; and

FIG. 4 is a front view of an alternative embodiment for at least drying wood and optionally storing said wood, wherein the wood may be placed directly on the ground or on a ground cover.

Like numbers to identify like parts and features will be used among the various figures, but not all features will be specifically identified in each illustration.

### DETAILED DESCRIPTION OF THE PREFERRED EMBODIMENTS

Generally speaking, reference is first had to FIGS. 1-3 in connection with the following for a complete disclosure and understanding of preferred embodiments of the present invention.

In a first embodiment, the present invention is directed to an arrangement, generally indicated at 10, for at least drying wood and optionally storing the wood, generally indicated at 100. Preferably, the wood 100 is firewood, but need not be, so as the wood itself need not be part of the broadest claims of the invention.

In a preferred embodiment, arrangement 10 comprises a framed structure, generally indicated at 20, for creating an area within the framed structure 20. By reference to the “area created” it is meant to reference the space, generally indicated at 30, created within the structure. Any number of shape and designs for the framed structure 20 can be used, such as those described in U.S. Design Pat. Nos. D415,571; D409,310; D654,187 and others as marketed and sold by ShelterLogic Corp, the assignee of the present invention, the subject matters of which are incorporated by reference as if fully set forth herein.

In a specific preferred embodiment, arrangement 10 may also comprise a support structure, generally indicated at 40, positionable in the area 30 created within the framed structure 20. Support structure 40 supports the wood 100 placed thereon, and preferably, the support structure is arranged so that wood 100 placed on the support structure 40 is spaced from the ground below, whereby air is permitted to flow intermediate the ground and the support structure.

Arrangement 10 also comprises a cover, generally indicated at 50, wherein the cover 50 is supported by the framed structure 20 and wherein the cover 50 (i) has water resistant properties for inhibiting water from entering the area 30 created within the framed structure 20 and (ii) allows infrared radiation to pass through the cover 50 to warm wood 100 supported on the ground, on a ground cover (as discussed below) and/or by the support structure 40 and positioned in the space 30 created within the framed structure 20, whereby warming of wood that has moisture therein permits evaporation of said moisture from said wood. It has been found by experimental data that a cover comprised of woven polyethylene fabric, and preferably of a green or clear polyethylene fabric, provides the optimal amount of infrared radiation to pass therethrough and into the area 30, and assists best in achieving the objectives and experimental results set forth herein.

Cover 50 is preferably constructed to (i) facilitate the escaping of some moisture from the arrangement 10 through one or more vents 60 in the cover 50 and (ii) collect other moisture on an inner surface 55 of the cover 50 and permit at least some of the other moisture (e.g. some of the moisture that collects on the inner surface 55 of the cover 50) to run down along the inner surface 55 of the cover 50 towards the ground.

It is also at this point advantageous to mention that a specific embodiment of the present invention provides that arrangement 10 comprises a ground cover, generally indicated at 70, for resisting percolation from the ground under the arrangement 10.

In this way, and with the inclusion of the ground cover 70, a preferred embodiment provides that a gap “G” can be maintained between the inner surface 55 of the cover 50 and the ground cover 70 (see FIG. 3) so that evaporated moisture that does not pass through the one or more vents 60 into the atmosphere and therefore which collects on the inner surface 55 of the cover 50 will form condensation and run down the inner surface 55 of the cover 50 between the gap G and the ground cover 70, thereby running into the ground beneath the arrangement 10. FIG. 3 particularly illustrates this latter feature. More specifically, as the wood 100 warms, the moisture in the form of water vapor is evaporated from the wood into the air in the arrangement 10. Some of the moisture escapes through the one or more vents 60 as the air expands from the warmth. The remaining moisture collects on the cooling fabric as the temperature is reduced from reduced solar radiation in the form of condensation. This condensation is taken by gravity as the water droplets increase in size, and through surface tension, pass within the gap G, between the inner cover layer 55 and the ground.

It should also be noted that even without ground cover 70, a gap “G” can be maintained between the inner surface 55 of the cover 50 and the support structure (or the ground itself when a support structure is not implemented) generally so that evaporated moisture that does not pass through the one or more vents 60 into the atmosphere and therefore which collects on the inner surface 55 of the cover 50 will form condensation and run down the inner surface 55 of the cover 50 between the gap G and the support structure 40 or the ground as the case may be, thereby running into the ground beneath the arrangement 10.

Reference is also made to FIG. 4, which is another preferred embodiment in which no support structure 40 is required, thereby providing that the wood lay directly on the ground or on a ground cover 70 (shown partly in FIG. 4 as an optional preferred embodiment). That is, ground cover 70 can be used for all the wood in this FIG. 4 embodiment, for only some of the wood, or may not be used at all. Such an option is likewise available for all embodiments herein. In any event, in these FIG. 4 configurations, the gap “G” can likewise be maintained between the inner surface 55 of the cover 50 and the ground or the ground cover 70, as the case may be, so that evaporated moisture that is not passing through the one or more vents 60 into the atmosphere and therefore which collects on the inner surface 55 of the cover 50 will form condensation and run down the inner surface 55 of the cover 50 between the gap G and the ground or the ground cover 70, as the case may be, thereby running into the ground beneath the arrangement, generally indicated at 1000. Here too therefore, as the wood 100 warms, the moisture in the form of water vapor is evaporated from the wood into the air in the arrangement 1000, as some of the moisture escapes through the one or more vents 60 as the air expands from the warmth and the remaining moisture collects on the cooling fabric as the temperature is reduced from reduced solar radiation in the form of condensation, which is taken by gravity as the water droplets increase in size, and through surface tension, pass within the gap G, between the inner cover layer 55 and the ground or ground cover, as the case may be.

In these ways, a system is created at least in part by the cover 50 and support structure 40 to accelerate the drying of the wood 100 placed in the arrangement 10.

In a specific embodiment, the framed structure 20 comprises metal tubing. Moreover, as stated above, in a specific embodiment, the wood placed on the support structure, ground and/or ground cover is suitable for and commonly known as “firewood.” In a further specific embodiment, the support structure 40 is arranged such that wood placed on the support structure 40 is sufficiently spaced from the ground below so as to at least partially inhibit crawling insects from climbing directly from the ground onto the wood 100.

In the preferred embodiments, the cover is selected so as to permit sufficient infrared radiation to pass through cover 50 so as to warm the wood in the arrangement while simultaneously keeping the wood dry from the elements (e.g. rain, snow) outside the arrangement.

Other advantageous features may be provided. For example, arrangement 10 may comprise one or more (e.g. a front and/or a rear) access doors, generally indicated at 80. Such door(s) 80 may be simple “roll up” doors, with zipper, snap, buttons, and/or hook and loop closures, all of which are a matter of design choice and well known in the art.

It has been discovered through experimentation that an arrangement constructed in accordance with the foregoing dries the wood to 20% moisture (maximum amount to meet EPA guidelines for wood burning furnaces) in only 43% of the time that it would take for that of uncovered wood and in only 50% of the time that it would take for that of wood covered by a conventional tarp, such as those found in the art cited by the inventors herein (i.e. non-woven polyethylene fabric).

That is, heretofore, it is believed that it has been unknown to utilize a cover as disclosed and claimed herein to cover and dry the wood as set forth herein.

In a specific embodiment, the arrangement comprises wood placed on the support structure, wherein the wood is suitable as firewood.

As can thus be seen, the present invention is also directed to an improved method of drying wood using an arrangement comprising a framed structure for creating an area within the framed structure; a cover, wherein the cover is supported by the framed structure and wherein the cover (i) has water resistant properties for inhibiting water from entering the area created within the framed structure and (ii) allows infrared radiation to pass through the cover to warm wood positioned in the space created within the framed structure, whereby warming of wood that has moisture therein permits evaporation of said moisture from said wood; and wherein the cover is further constructed to (i) facilitate the escaping of some moisture from the arrangement through one or more vents in the cover and (ii) collect other moisture on an inner surface of the cover and permit at least some of the other moisture to run down along the inner surface of the cover towards the ground; wherein the method comprises the steps of warming the wood via infrared radiation passing through the cover; evaporating moisture in the wood; venting at least some of the moisture evaporated from the wood; collecting at least some other moisture evaporated from the wood on the inner surface of the cover and permitting at least some of the other moisture to run down along the inner surface of the cover towards the ground; wherein a system is created at least in part by the cover to accelerate the drying of the wood positioned in the area created by the framed structure.

In a specific embodiment, the arrangement comprises a support structure positionable in the area created within the framed structure, the support structure for supporting wood placed thereon, wherein the support structure is arranged so that wood placed on the support structure is spaced from the ground below, and wherein the method comprises the step of permitting air to flow intermediate the ground and the support structure.

Thus, in a more specific embodiment, the method may comprise the step of permitting at least some of the other moisture to run down along the inner surface of the cover into a gap formed intermediate the support structure and the inner surface of the cover, and wherein the at least some of the other moisture runs into the ground. In an alternative embodiment, the arrangement comprises a ground cover (with and/or without the support structure), and the method comprises the step of permitting at least some of the other moisture to run down along the inner surface of the cover into a gap formed intermediate the ground cover and the inner surface of the cover, and wherein the at least some of the other moisture runs into the ground.

It can thus be seen that the present invention provides an improved method and arrangement for accelerating the drying time of wood with improved efficiency over that found in the state of the art. Moreover, such objectives and results are achieved using a shed-like arrangement that can be easily constructed, maintained and even disassembled, if needed.

It is also to be understood that the following claims are intended to cover all of the generic and specific features of the invention described herein and all statements of the scope of the invention which as a matter of language might fall therebetween.

What we claim is:

1. An arrangement for drying wood, the arrangement comprising:
a framed structure for creating an area within the framed structure;
a cover, wherein the cover is supported by the framed structure and wherein the cover (i) has water resistant properties for inhibiting water from entering the area created within the framed structure and (ii) allows infrared radiation to pass through the cover to warm wood positioned in the space created within the framed structure, whereby warming of wood that has moisture therein permits evaporation of said moisture from said wood; and
wherein the cover is further constructed to (i) facilitate the escaping of some moisture from the arrangement through one or more vents in the cover and (ii) collect other moisture on an inner surface of the cover and permit at least some of the other moisture to run down along the inner surface of the cover towards the ground;
wherein a system is created at least in part by the cover to accelerate the drying of the wood positioned in the area created within the framed structure.

2. The arrangement as claimed in claim 1, comprising a support structure positionable in the area created within the framed structure, the support structure for supporting wood placed thereon, wherein the support structure is arranged so that wood placed on the support structure is spaced from the ground below, whereby air is permitted to flow intermediate the ground and the support structure, wherein a system is created at least in part by the cover and the support structure to accelerate the drying of the wood stored in the arrangement.

3. The arrangement as claimed in claim 2, comprising a gap intermediate the support structure and the inner surface of the cover, and wherein at least some of the other moisture runs down along the inner surface of the cover into the gap and into the ground.

4. The arrangement as claimed in claim 1, comprising a ground cover and a gap intermediate the ground cover and the inner surface of the cover, and wherein at least some of the other moisture runs down along the inner surface of the cover into the gap and into the ground.

5. The arrangement as claimed in claim 4, comprising a support structure positionable in the area created within the framed structure, the support structure for supporting wood placed thereon, wherein the support structure is arranged so that wood placed on the support structure is spaced from the ground below, whereby air is permitted to flow intermediate the ground and the support structure, wherein a system is created at least in part by the cover and the support structure to accelerate the drying of the wood stored in the arrangement.

6. The arrangement as claimed in claim 1, wherein the framed structure comprises metal tubing.

7. The arrangement as claimed in claim 2, including wood placed on the support structure, wherein the wood is suitable as firewood.

8. The arrangement as claimed in claim 2, wherein the support structure is arranged such that wood placed on the support structure is sufficiently spaced from the ground below so as to at least partially inhibits crawling insects from climbing directly from the ground onto the wood.

9. The arrangement as claimed in claim 1, wherein the cover is comprised of woven polyethylene fabric.

10. The arrangement as claimed in claim 1, wherein the cover is comprised of green or clear polyethylene fabric.

11. A method of drying wood using an arrangement comprising a framed structure for creating an area within the framed structure; a cover, wherein the cover is supported by the framed structure and wherein the cover (i) has water resistant properties for inhibiting water from entering the area created within the framed structure and (ii) allows infrared radiation to pass through the cover to warm wood positioned in the space created within the framed structure, whereby warming of wood that has moisture therein permits evaporation of said moisture from said wood; and wherein the cover is further constructed to (i) facilitate the escaping of some moisture from the arrangement through one or more vents in the cover and (ii) collect other moisture on an inner surface of the cover and permit at least some of the other moisture to run down along the inner surface of the cover towards the ground; the method comprising the steps of:
warming the wood via infrared radiation passing through the cover;
evaporating moisture in the wood;
venting at least some of the moisture evaporated from the wood;
collecting at least some other moisture evaporated from the wood on the inner surface of the cover and permitting at least some of the other moisture to run down along the inner surface of the cover towards the ground;
wherein a system is created at least in part by the cover to accelerate the drying of the wood positioned in the area created by the framed structure.

12. The method as claimed in claim 11, wherein the arrangement comprises a support structure positionable in the area created within the framed structure, the support structure for supporting wood placed thereon, wherein the support structure is arranged so that wood placed on the support structure is spaced from the ground below, and wherein the method comprises the step of permitting air to flow intermediate the ground and the support structure.

13. The method as claimed in claim 12, comprising the step of permitting at least some of the other moisture to run down along the inner surface of the cover into a gap formed intermediate the support structure and the inner surface of the cover, and wherein the at least some of the other moisture runs into the ground.

14. The method as claimed in claim 11, wherein the arrangement comprises a ground cover, and wherein the method comprises the step of permitting at least some of the other moisture to run down along the inner surface of the cover into a gap formed intermediate the ground cover and the inner surface of the cover, and wherein the at least some of the other moisture runs into the ground.
